(19) United States
(12) Patent Application Publication
(10) Pub. No.: US 2021/0131683 A1
(43) Pub. Date: May 6, 2021

(54) AIR EXHAUST DEVICE, AIR CONDITIONING SYSTEM AND THE CONTROL METHOD THEREFOR

(71) Applicant: Carrier Corporation, Palm Beach Gardens, FL (US)

(72) Inventors: Dan Zhao, Shanghai (CN); Xinglei Zhang, Shanghai (CN); Wei Huang, Shanghai (CN)

(21) Appl. No.: 17/084,098

(22) Filed: Oct. 29, 2020

(30) Foreign Application Priority Data
Nov. 5, 2019 (CN) 201911071462.1

(51) Int. Cl. F24F 3/16; F24F 13/30; F24F 13/20; F24F 11/77

(52) U.S. Cl. CPC F24F 3/166; F24F 13/30; F24F 3/1603; F24F 2110/65; F24F 11/77; F24F 2003/1682; F24F 2013/205; F24F 13/20

(57) ABSTRACT

An air outlet device, an air conditioning system, and a control method therefor. The air outlet device is for use in an air conditioning system, and includes: an air outlet device for an air conditioning system, including: a heat exchanger that exchanges heat with the air flowing through; a fan device that drives the air to flow through the heat exchanger; a formaldehyde removal part coated with a formaldehyde removal coating that can catalyze the decomposition of formaldehyde into water and carbon dioxide; a housing for accommodating the heat exchanger, the fan device, and the formaldehyde removal part; and a controller for controlling the start and stop of the fan device. According to the air outlet device, the air conditioning system, and the control method therefor of the present application, the air is purified by providing a formaldehyde removal part in the housing of the air outlet device.

### FOREIGN PRIORITY

This application claims priority to Chinese Patent Application No. 201911071462.1, filed Nov. 5, 2019, and all the benefits accruing therefrom under 35 U.S.C. § 119, the contents of which in its entirety are herein incorporated by reference.

### TECHNICAL FIELD OF INVENTION

The present application relates to the field of air conditioning. More specifically, the present application relates to an air outlet device with an air purification function, an air conditioning system, and a control method therefor.

### BACKGROUND OF THE INVENTION

Air conditioning equipment belongs to a well-developed technical field, and it plays a role in regulating air temperature and humidity. Air purification equipment also belongs to a field that is newly emerging and rapidly developing in recent years, and it plays a role in improving air quality. The rapid development of air purification equipment has benefited from human beings' increasing attention to the health of the living environment. For example, particulates such as PM2.5, formaldehyde and other volatile organic compounds (VOCs) are all harmful to health and are extremely common in the existing living environment. Therefore, it is desirable that air purification equipment is provided to eliminate these hazards.

Compared with air purification equipment, air conditioning equipment is more popular. Therefore, if air purification components can be integrated into the air conditioning equipment and sold together, the health of the living environment of users can be more widely improved. However, on the one hand, considering that the structural space of the air conditioning equipment is limited, it is difficult to carry a large air purification filter element; on the other hand, considering that the air conditioning equipment is usually in a fixed state once the installation is completed, the replacement of the filter element in it is relatively complicated. Therefore, there is no effective solution to integrate the two at present.

### SUMMARY OF THE INVENTION

The present application provides an air outlet device, an air conditioning system, and a control method therefor, so as to at least solve or alleviate some of the problems in the prior art.

In order to achieve at least one objective of the present application, according to one aspect of the present application, an air outlet device for an air conditioning system is provided, which comprises: a heat exchanger that exchanges heat with the air flowing through; a fan device that drives the air to flow through the heat exchanger; a formaldehyde removal part coated with a formaldehyde removal coating that can catalyze the decomposition of formaldehyde into water and carbon dioxide; a housing for accommodating the heat exchanger, the fan device, and the formaldehyde removal part; and a controller for controlling the start and stop of the fan device.

Optionally, the formaldehyde removal part is integrated into the heat exchanger.

Optionally, the formaldehyde removal part is integrated on a part of the heat exchanger located downstream of the air flow direction.

Optionally, the air outlet device further comprises: the formaldehyde removal part is a porous filter element arranged downstream of the heat exchanger.

Optionally, the air outlet device further comprises: an anion generating device arranged in the housing and upstream of the heat exchanger that ionizes the air flowing through to generate anions, wherein the anions cause PM2.5 particles in the air to carry charges and accumulate; the controller is further used to control the start and stop of the anion generating device.

Optionally, the anion generating device comprises a connecting rod and a plurality of anion generators uniformly arranged on the connecting rod, wherein the plurality of anion generators are respectively used to ionize the air flowing through to generate anions.

Optionally, the air outlet device further comprises a sensor for sensing the concentration of PM2.5 in the air, and the controller controls the start and stop of the fan and the anion generating device based on the sensing data of the sensor.

In order to achieve at least one objective of the present application, according to another aspect of the present application, an air conditioning system is further provided, which comprises: the aforementioned air outlet device and a refrigeration circuit; the heat exchanger in the air outlet device is connected to the refrigeration circuit through a pipeline.

In order to achieve at least one objective of the present application, according to still another aspect of the present application, a control method for an air conditioning system, which is used in the aforementioned air conditioning system, is further provided. The control method comprises: an air conditioning mode that starts the refrigeration circuit and the fan device, and drives the air to flow through the heat exchanger for heat exchange; a PM2.5 removal mode that starts the anion generating device and the fan device, and drives the air to flow through the anion generating device for ionization to generate anions, wherein the anions cause PM2.5 particles in the air to carry charges and aggregate; and wherein, the air conditioning mode and the PM2.5 removal mode are started alternatively or simultaneously in a controlled manner.

Optionally, the control method further comprises: a heat exchange self-cleaning mode, which reduces the operating speed of the fan device, so that the condensed water condensed on the heat exchanger washes the PM2.5 aggregated particles settled on the heat exchanger; wherein the heat exchange self-cleaning mode is set to be a controlled start or a timing start.

According to the air outlet device, air conditioning system, and control method therefor of the present application, a formaldehyde removal part is arranged in the housing of the air outlet device to catalyze the air flowing through, so that the formaldehyde contained therein is decomposed into water and carbon dioxide, thereby effectively eliminating or alleviating the harm of formaldehyde. Under this configuration, the formaldehyde in the air stream flowing out from the air outlet device can be effectively removed, so that the air quality can be greatly improved, and the impact on human health can be avoided. In addition, the formaldehyde removal part can decompose formaldehyde by means of catalyzing, so there is almost no loss, and there is no need to replace consumables. Therefore, a solution for an integrated device that can reliably achieve air conditioning and purification is provided.

### BRIEF DESCRIPTION OF THE DRAWINGS

FIG. 1 is a schematic side view of an embodiment of the air outlet device of the present application.

FIG. 2 is a schematic top view of an embodiment of the air outlet device of the present application.

FIG. 3 is a schematic side view of another embodiment of the air outlet device of the present application.

FIG. 4 is a schematic top view of another embodiment of the air outlet device of the present application.

### DETAILED DESCRIPTION OF THE INVENTION

First, it should be noted that the composition, operating principle, characteristics, advantages, and the like of the air outlet device, air conditioning system, and control method therefor according to the present application are illustrated below by examples. However, it should be understood that all the descriptions are given for illustrative purposes only, and therefore should not be construed as limiting the present invention.

In addition, for any single technical feature described or implied in the embodiments mentioned herein, or any single technical feature displayed or implied in each drawing, the present application still allows any continued arbitrary combination or deletion of these technical features (or the equivalents thereof) without any technical obstacles, thereby obtaining more other embodiments of the present application that may not be directly mentioned herein.

Furthermore, with regard to the present application, it should be noted that the anion generating device used herein belongs to a mature technology, which can generate instantaneous high voltage with relatively low power to ionize the air to generate anions, and to charge the particles around the ionized air, so as to cause agglomeration and sedimentation. In addition, anions can also be used for sterilization and deodorization.

As an interpretation for another type of terms in the present application, the aforementioned “upstream” and “downstream” are usually used to indicate the relative orientation on the trajectory where the air in the air outlet device is driven to flow. “Upstream” means that a feature is at or closer to the starting point of the air flow trajectory, and “downstream” means that a feature is at or closer to the end point of the air flow trajectory.

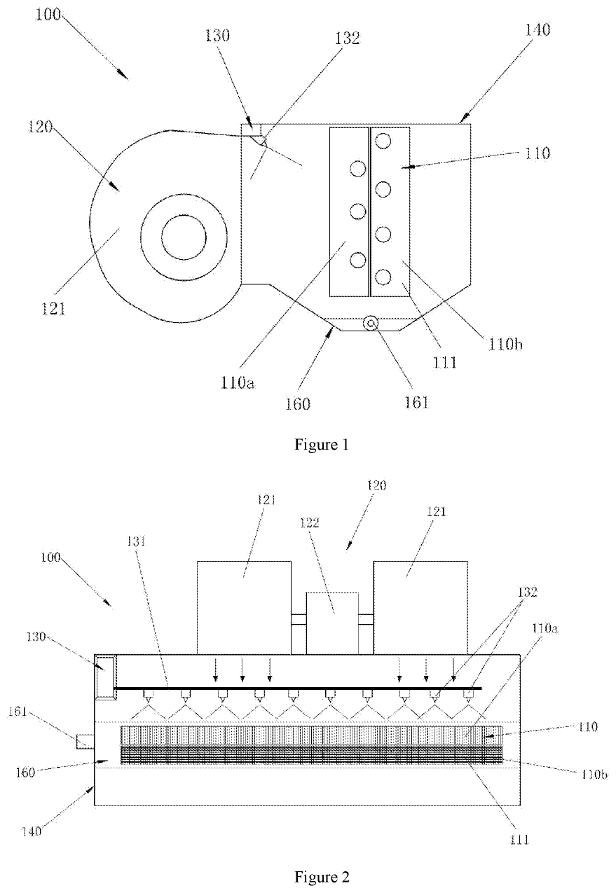

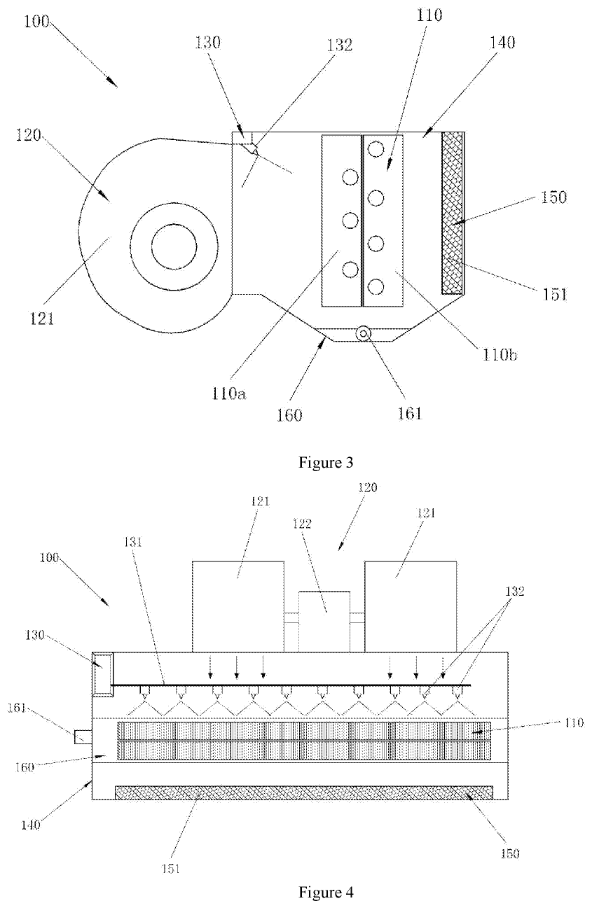

Returning to the present application, the schematic structure of an embodiment of the air outlet device according to the present application is shown only schematically from different angles in FIGS. 1 and 2. The schematic structure of another embodiment of the air outlet device according to the present application is only schematically shown from different angles in FIGS. 3 and 4. The technical solutions of the present invention will be described in detail below in conjunction with the above drawings.

Referring to FIGS. 1 to 4, the present application provides an air outlet device 100 for an air conditioning system. The air outlet device 100 comprises a housing 140, a heat exchanger 110 disposed in the housing 140, a fan device 120, and a formaldehyde removal part coated with a formaldehyde removal coating; it further comprises a controller (not shown in the figures) for controlling the start and stop of the fan device 120, wherein the controller may not be limited to be arranged in the housing 140, and may also be arranged separately or integrated with other controllers of the air conditioning system to which the air outlet device is applied. Specifically, the fan device 120 has a fan 121 and a drive motor 122 that can drive air to flow through the heat exchanger 110 for heat exchange. To achieve this function, the fan device 120 may be arranged upstream of the heat exchanger 110 in the housing 140 to blow air or arranged downstream of the heat exchanger 110 to draw air. In the illustrated embodiment, the fan device 120 is arranged upstream of the heat exchanger 110. The formaldehyde removal part provided in the air outlet device can be arranged on the trajectory where the air is driven to flow by the fan device 120, to catalyze the air flowing through so as to decompose the formaldehyde contained therein into water and carbon dioxide, thereby effectively eliminating or alleviating the harm of formaldehyde. Under this configuration, the formaldehyde in the air stream flowing out from the air outlet device can be effectively removed, so that the air quality can be greatly improved, and the impact on human health can be avoided.

On the basis of the foregoing embodiments, some modifications can also be made to the various parts of the air outlet device or the connection positional relationships thereof to obtain other technical effects, which will be exemplified as follows.

For example, referring to FIGS. 1 to 2, the air outlet device 100 further comprises a formaldehyde removal coating 111 coated on a part of the heat exchanger 110. The formaldehyde removal coating 111 can catalyze the rapid decomposition of formaldehyde contained in the air flowing through it into water and carbon dioxide, thereby effectively eliminating or alleviating the harm of formaldehyde. In addition, the other part of the heat exchanger 110 that is not coated with the formaldehyde removal coating 111 can maintain a high-efficiency heat exchange operating state, thereby balancing the heat exchange performance of the air conditioning mode and the formaldehyde removal effect to be carried out by it.

Continuing to refer to FIGS. 1 to 2, as a specific example of the coating position of the formaldehyde removal coating 111, the formaldehyde removal coating 111 can be coated on a part of the heat exchanger 110 downstream of the air flow. For example, the figures show the downstream section 110b of the heat exchanger. Because the air outlet device may generate condensed water during the air conditioning process, while the condensed water is more likely to condense at the upstream of the heat exchanger 110, and too much water will affect the catalytic efficiency of the formaldehyde removal coating 111, coating the formaldehyde removal coating 111 on a part downstream of the heat exchanger 110 can therefore effectively solve the problem that the condensed water affects the catalytic efficiency.

As another example, referring to FIGS. 3 to 4, as another specific example of the coating position of the formaldehyde removal coating, the air outlet device may additionally comprise a porous filter element 150 coated with a formaldehyde removal coating 151 arranged in the housing 140. For example, the porous filter element 150 may be a honeycomb filter element with large pores, so that it has a small wind resistance. Therefore, the addition of the porous filter element 150 will not have too much influence on the air-out of the air outlet device. The formaldehyde removal coating 151 can catalyze the rapid decomposition of formaldehyde contained in the air flowing through it into water and carbon dioxide, thereby effectively eliminating or alleviating the harm of formaldehyde. In addition, since the heat exchanger 110 is no longer coated with the formaldehyde removal coating 151, it can maintain a high-efficiency heat exchange operating state, thereby balancing the heat exchange performance of the air conditioning mode and the formaldehyde removal effect to be carried out by the air outlet device.

Continuing to refer to FIGS. 3 to 4, as a specific example of the arrangement position of the porous filter element 150, the porous filter element 150 may be arranged downstream of the heat exchanger 110. Because the air outlet device may generate condensed water during the air conditioning process, while the condensed water is more likely to condense at the upstream of the heat exchanger 110, and too much water will affect the catalytic efficiency of the formaldehyde removal coating 151, arranging the porous filter element 150 coated with the formaldehyde removal coating 151 at the downstream of the heat exchanger 110 can therefore effectively solve the problem that the condensed water affects the catalytic efficiency.

The formaldehyde removal coating used in the present application also belongs to a mature technology. For example, it can be selected from the formaldehyde removal catalyst (formaldpuretm catalyst) produced by BASF. It mainly acts as a chemical reaction medium, which does not react with formaldehyde by itself, but catalyzes the accelerated reaction of formaldehyde to decompose it into water and carbon dioxide, two products that are harmless to the environment. Therefore, there is almost no loss during the application process and it has a long service life, so there is no need for frequent replacement.

Any of the foregoing embodiments or combinations thereof can effectively alleviate the harm of formaldehyde in the air. On this basis, the present application further provides more embodiments to alleviate the harm of PM2.5, another pollution source in the air.

For example, referring to FIGS. 1 to 4, the air outlet device may also be provided with an anion generating device 130 in the housing 140. The anion generating device 130 can ionize the air flowing through to generate anions, wherein the anions cause PM2.5 particles in the air to carry charges and accumulate, and at the same time can achieve the effects of sterilization and deodorization. At this time, the aforementioned controller is also correspondingly used to control the start and stop of the anion generating device. Under this configuration, on the one hand, large particles will settle in the air outlet device or on the wall or ground of the room to be cleaned; on the other hand, large particles are difficult to be inhaled by the human body and cause health hazards. In addition, the structure of the anion generating device occupies less space, and the device is almost lossless, so there is no need to replace consumables. Therefore, the foregoing embodiments of the present application provide a solution for an integrated device that can reliably achieve air conditioning and purification.

On this basis, continuing to refer to FIGS. 1 to 4, as a specific example of the installation position of the anion generating device 130, the anion generating device 130 can be arranged upstream of the heat exchanger 110, so that it is relatively closer to the upstream section 110a of the heat exchanger 110 and is further away from the downstream section 110b of the heat exchanger 110. On the one hand, the relative temperature difference between the air and the refrigerant in the heat exchanger 110 at this place is relatively large, so it is easier to condense the condensed water; on the other hand, the PM2.5 aggregated particles formed into agglomerates after being ionized by the anion generating device 130 are likely to settle on the heat exchange tubes or heat exchange fins of the heat exchanger closest to the anion generating device 130 in the downwind direction. At this time, it will be easier for PM2.5 aggregated particles to be washed and removed by the condensed water condensed on the heat exchanger 110. For example, they can drip into the drainage tray 160 under the heat exchanger 110 and leave the air outlet device 110 through the drain pipe 161.

Continuing to refer to FIGS. 1 to 4, as a specific example of the structure and construction of the anion generating device 130, the anion generating device 130 may comprise a connecting rod 131 and a plurality of anion generators 132 uniformly arranged on the connecting rod 131, wherein the plurality of anion generators 132 are respectively used to ionize the air flowing through to generate anions. Among them, the connecting rod 131 plays a role of supporting the anion generators 132 and serving as a power supply line to power the anion generators 132. This configuration enables the anion generating device 130 to spray anions more uniformly, so that the air flowing through it can be more uniformly and fully ionized, thereby facilitating the aggregation of PM2.5 in the air to promote sedimentation.

In addition, although not shown in the figures, the air outlet device may also comprise a sensor for sensing the concentration of PM2.5 in the air, so as to provide a judgment basis for the start and stop control of the controller accordingly. At this time, the controller can control the start and stop of the fan device 120 and the anion generating device 130 based on the sensing data of the sensor, thereby providing a complete start and stop control logic of the anion generating device 130 and the start and stop control logic of the fan device when the anion generating device functions. As an example, when the concentration of PM2.5 in the air is too high, the anion generating device and the fan device should be controlled to start. However, if the air outlet device is already in the air conditioning mode (for example, cooling or heating) at this time, the fan device is still to be remained in the starting state, with no additional intervention to control the fan device. If, however, the air outlet device is not in the air conditioning mode at this time, the controller correspondingly controls both the anion generating device and the fan device to start.

In addition, although not shown in the figures, an embodiment of an air conditioning system is further provided herein, in which any embodiments of the aforementioned air outlet device 100 or combinations thereof can be arranged. The air conditioning system further comprises a refrigeration circuit that can be conventionally used to perform air conditioning functions, and the heat exchanger 110 in the air outlet device 100 is connected to the refrigeration circuit through a pipeline, which is used in the refrigeration circuit as an evaporator or a condenser accordingly. The air conditioning system can thus also have the technical effects brought about by the aforementioned technical solutions.

It should be noted that the other parts of the air outlet device and the air conditioning system provided according to the present application can be designed, manufactured, and sold separately, or they can be assembled together and then sold as a whole. Regardless of the monomers formed before the combination or the whole formed after the combination, they all fall into the protection scope of the present application.

Furthermore, although not shown in the figures, an embodiment of a control method for an air conditioning system is further provided herein, which can be used in any embodiments of the aforementioned air conditioning system or combinations thereof. Specifically, the control method comprises a conventional air conditioning mode and a PM2.5 removal mode. Among them, in the air conditioning mode, the refrigeration circuit and the fan device 120 are activated to drive air to flow through the heat exchanger 110 for heat exchange, and then the cooled or heated air enters the room for cooling or heating. In the PM2.5 removal mode, the anion generating device 130 and the fan device 120 are controlled to start. At this time, the air is driven to flow through the anion generating device 130 for ionization to generate anions. The anions cause the PM2.5 particles in the air to carry charges and aggregate to form PM2.5 aggregated particles. After that, the air carrying PM2.5 aggregated particles continues to be driven by the fan device 120 to flow through the heat exchanger 110 to exchange heat. At the same time, a part of the PM2.5 aggregated particles may settle on the heat exchange tubes or heat exchange fins of the heat exchanger 110 to be washed and removed by the condensed water later, while another part of the PM2.5 aggregated particles are blown into the room with the air, and then settle on the wall or the ground of the room to be cleaned. As these PM2.5 aggregated particles usually have a larger size, they are difficult to be inhaled by the human body and cause health hazards. In addition, based on the actual situation, the air conditioning mode and the PM2.5 removal mode can be controlled to be activated alternatively or simultaneously, and the respective technical effects can be achieved accordingly.

On this basis, the control method may also comprise a heat exchange self-cleaning mode. At this time, the operating speed of the fan device 120 should be reduced, so that there is a greater temperature difference between the refrigerant in the heat exchanger 110 and the air flowing through the heat exchanger 110, and a large amount of condensed water is generated. Subsequently, the large amount of condensed water condensed on the heat exchanger 110 can wash the PM2.5 aggregated particles settled on the heat exchanger 110, causing them to drip into the drainage tray 160 under the heat exchanger 110 and leave the air outlet 110 through the drain pipe 161. In addition, the heat exchange self-cleaning mode can be controlled to start based on the actual situation or directly set to a timing start to achieve the effect of removing PM2.5 aggregated particles on the surface of the heat exchanger as needed.

The above examples mainly illustrate the air outlet device, the air conditioning system and the control method therefor of the present application. Although only some of the embodiments of the present application have been described, those skilled in the art should understand that the present application can, without departing from its spirit and scope, be implemented in many other forms. Therefore, the illustrated examples and embodiments are to be considered as illustrative but not restrictive, and the present application may cover various modifications or replacements if not departed from the spirit and scope of the present application as defined by the appended claims.

What is claimed is:

1. An air outlet device for an air conditioning system, comprising:
a heat exchanger that exchanges heat with the air flowing through;
a fan device that drives the air to flow through the heat exchanger;
a formaldehyde removal part coated with a formaldehyde removal coating that can catalyze the decomposition of formaldehyde into water and carbon dioxide;
a housing for accommodating the heat exchanger, the fan device, and the formaldehyde removal part; and
a controller for controlling the start and stop of the fan device.

2. The air outlet device according to claim 1, wherein the formaldehyde removal part is integrated into the heat exchanger.

3. The air outlet device according to claim 2, wherein the formaldehyde removal part is integrated on a part of the heat exchanger located downstream of the air flow direction.

4. The air outlet device according to claim 1, wherein the formaldehyde removal part is a porous filter element arranged downstream of the heat exchanger.

5. The air outlet device according to claim 1, further comprising: an anion generating device arranged in the housing and upstream of the heat exchanger that ionizes the air flowing through to generate anions, wherein the anions cause PM2.5 particles in the air to carry charges and accumulate; and wherein the controller is further used to control the start and stop of the anion generating device.

6. The air outlet device according to claim 5, wherein the anion generating device comprises a connecting rod and a plurality of anion generators uniformly arranged on the connecting rod, wherein the plurality of anion generators are respectively used to ionize the air flowing through to generate anions.

7. The air outlet device according to claim 5, further comprising: a sensor for sensing the concentration of PM2.5 in the air, and the controller controls the start and stop of the fan device and the anion generating device based on the sensing data of the sensor.

8. An air conditioning system, comprising: the air outlet device according to claim 1, and a refrigeration circuit; the heat exchanger in the air outlet device is connected to the refrigeration circuit through a pipeline.

9. A control method for an air conditioning system used in the air conditioning system according to claim 8, comprising:
an air conditioning mode that starts the refrigeration circuit and the fan device to drive the air to flow through the heat exchanger for heat exchange;
a PM2.5 removal mode that starts the anion generating device and the fan device to drive the air to flow through the anion generating device for ionization to generate anions, wherein the anions cause PM2.5 particles in the air to carry charges and aggregate; and
wherein, the air conditioning mode and the PM2.5 removal mode are started alternatively or simultaneously in a controlled manner.

10. The control method according to claim 9, further comprising: a heat exchanger self-cleaning mode that reduces the operating speed of the fan device, so that the condensed water condensed on the heat exchanger washes the PM2.5 aggregated particles settled on the heat exchanger; wherein the heat exchange self-cleaning mode is set to be a controlled start or a timing start.
